(19) United States
(12) Patent Application Publication
(10) Pub. No.: US 2023/0040155 A1
(43) Pub. Date: Feb. 9, 2023

(54) Candle Holder

(71) Applicant: Simone Halstead, Sheridan, WY (US)

(72) Inventor: Simone Halstead, Sheridan, WY (US)

(21) Appl. No.: 17/585,626

(22) Filed: Jan. 27, 2022

Related U.S. Application Data
(60) Provisional application No. 63/143,793, filed on Jan. 30, 2021.

(51) Int. Cl. F21V 35/00

(52) U.S. Cl. CPC F21V 35/003

(57) ABSTRACT

An apparatus includes a base defining a first surface and a second surface. The first surface defining a plurality of receptacles for receiving one or more ignitable light sources and/or at least one flower. A wall extends from the first surface of the base. A lid is positioned along a rim defined by the wall, the lid defining a plurality of apertures for receive one or more ignitable light sources and/or one or more flower.

### FIELD

The present disclosure relates generally to a candle holder. More particularly, the present disclosure relates to an apparatus for receiving one or more ignitable light sources, such as a candle. The present disclosure also relates to an apparatus configured for receiving or holding one or more flowers. The one or more ignitable light sources and/or flowers are arranged in a predetermined pattern.

### BACKGROUND

Candles are used for example in churches and oilier religious buildings, celebrations, houses, restaurants, hotels, bars, other catering establishments and health spas. Generally the candles are placed in candle holders before and during use wherein the candle holder holds the candle before the candle is lit and whilst the candle is burning.

The present disclosure generally relates to a candle holder that is designed so that one or more candles are separated by a distance sufficient enough to allow for an acceptable burn rate. The multiples of candles (e.g., 17, 21, or 25) that are displayed in each unit have been selected to allow for particularly popular birthday celebrations as well as religious celebrations and more generally any kind of event where an eye-catching, glowing, table centerpiece is desired. Alternatively, or in addition to, the apparatus is also configured to receive one or more flowers. In one example, a two piece, lidded candle and/or flower holder design, able to display specific multiples of candles and/or flowers, is provided.

### SUMMARY

According to an arrangement, an apparatus is disclosed comprising a base defining a first surface and a second surface, the first surface defining a plurality of receptacles for receiving one or more ignitable light sources and/or flowers. A wall extending from the first surface of the base, and a lid positioned along a rim defined by the wall. The lid defining a plurality of apertures for receiving one or more ignitable light sources and/or flowers.

According to an arrangement, the plurality of receptacles defined by the first surface of the base comprises a first pattern of receptacles. According to an arrangement, the first pattern of receptacles comprises a first circle of receptacles and a second circle of receptacles.

According to an arrangement, the plurality of apertures defined by the lid comprise a second pattern. According to an arrangement, the second pattern comprises a first circle of apertures and a second circle of apertures.

According to an arrangement, the plurality of receptacles defined by the first surface of the base comprise a first pattern of receptacles. The plurality of apertures defined by the lid comprise a second pattern. The first pattern of receptacles defined by the first surface of the base is substantially similar to the second pattern of apertures defined by the lid.

According to an arrangement, the plurality of receptacles comprise a plurality of circular receptacles.

According to an arrangement, the plurality of apertures comprise a plurality of circular apertures.

According to an arrangement, each of the plurality of receptacles comprises a substantially similar size receptacle.

According to an arrangement, each of the plurality of apertures comprises a substantially similar size aperture.

According to an arrangement, the base comprises a waterproof base.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a perspective view of an apparatus for use with at least one ignitable light source and/or flower, according to an example embodiment;

FIG. 2 illustrates a perspective view of the apparatus illustrated in FIG. 1;

FIG. 3 illustrates a perspective view of a base that may be used with an apparatus for use with at least one ignitable light source and/or flower, such as the apparatus illustrated in FIG. 1;

FIG. 4 illustrates a perspective view of a lid that may be used with an apparatus for use with at least one ignitable light source and/or flower, such as the base illustrated in FIG. 3;

FIG. 5 illustrates a perspective view of an alternative base that may be used with an apparatus for use with at least one ignitable light source and/or flower;

FIG. 6 illustrates a perspective view of a lid that may be used with an apparatus for use with at least one ignitable light source and/or flower, such as the base illustrated in FIG. 5;

FIG. 7 illustrates a perspective view of an alternative base that may be used with an apparatus for use with at least one ignitable light source and/or flower; and

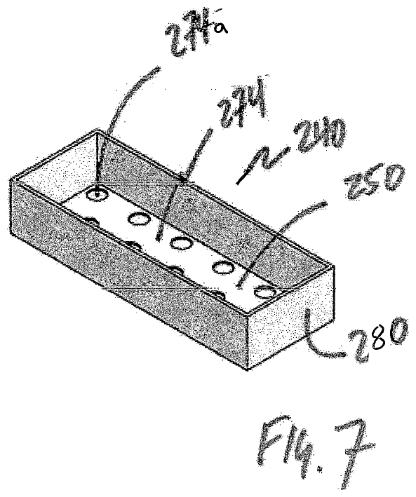

FIG. 8 illustrates a perspective view of a lid that may be used with an apparatus for use with at least one ignitable light source and/or flower, such as the base illustrated in FIG. 7.

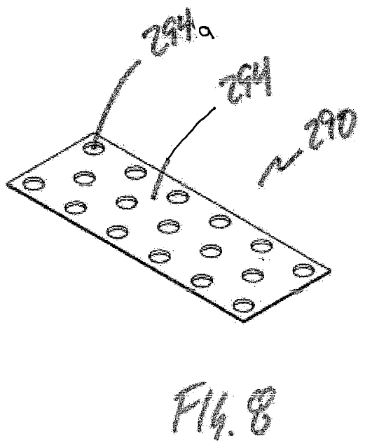

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the-claims is for purposes of clarity. Therefore, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

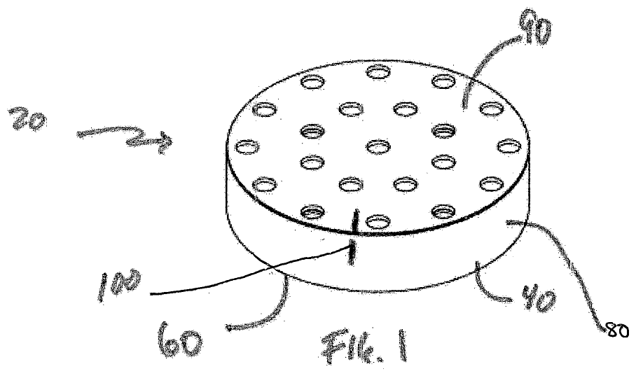

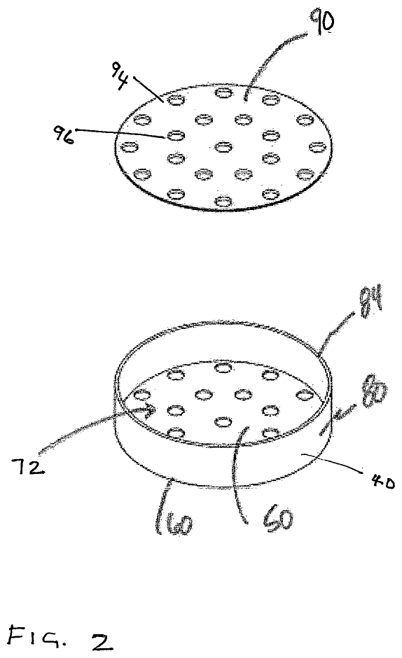

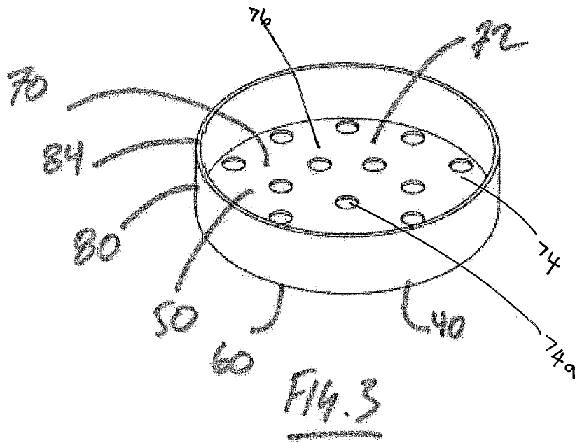

FIG. 1 illustrates a perspective view of an apparatus 20 for use with at least one ignitable light source and/or flower, according to an example embodiment. Referring to FIG. 1, disclosed is an apparatus 20 comprising a base 40. For example, FIG. 3 illustrates a perspective view of a base 40 that may be used with an apparatus for use with at least one ignitable light source, such as the apparatus 20 illustrated in FIG. 1. The base 40 defines a first surface 50 (FIG. 2) and a second surface 60. In one preferred arrangement, the first surface 50 of the base 40 defines a plurality of receptacles 70 for receiving one or more ignitable light sources and/or one or more flowers. For example, the first surface 50 of the base 40 defines a plurality of receptacles 70 for receiving one or more candles and/or flowers. Each of the plurality of receptacles may comprise a depth of about 0.1 to about 0.250 inches. Alternative depth configurations may also be utilized.

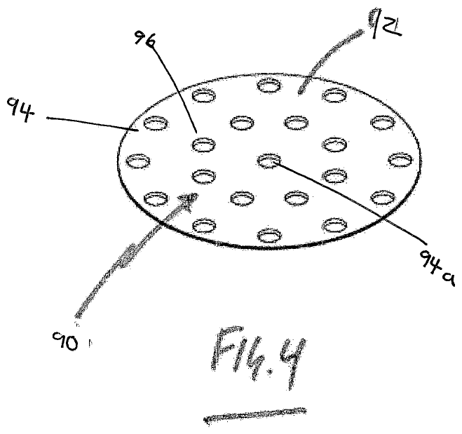

The apparatus 20 further comprises a wall 80 extending from the first surface 50 of the base. The apparatus 20 further comprises a lid 90 that is positioned along a rim 84 defined by the wall 80. For example, the lid 90 may be removably positioned along the rim 84 of the wall 80. Alternatively, the lid 90 may be pivotably positioned along the rim 84 of the wall 80. In this illustrated arrangement, the lid 90 comprises a circular lid. In one preferred arrangement, an outer edge of the lid 90 defines a cutout 94 (see FIGS. 2 and 4) that allows the lid 90 to be seated along the rim 84 of the wall 80.

The wall 80 may comprise a single wall structure, although other wall structures may also be used. In one preferred arrangement, the lid 90 defines a plurality of apertures 94 for receiving one or more ignitable light sources and/or one or more flowers. The light source may comprise a taper candle.

FIG. 2 illustrates a perspective view of the apparatus 20 illustrated in FIG. 1. Referring now to FIGS. 2 and 3, the plurality of receptacles 70 defined by the first surface 50 of the base 40 comprises a first pattern of receptacles 72. In one preferred arrangement, this first pattern of receptacles 72 comprises a first circle of receptacles 74 and a second circle of receptacles 76. In one preferred arrangement, the plurality of receptacles 74 comprise a plurality of circular shaped receptacles. In the illustrated apparatus, each of the plurality of circular shaped receptacles comprise a substantially similar size receptacle. However, other sized receptacles may also be utilized. Alternatively, each of the plurality of circular shaped receptacles or perhaps just a few of the circular shaped receptacles comprise a substantially similar size receptacle. As those of ordinary skill in the art will recognize, alternative receptacle configurations may also be used.

In one preferred arrangement, as illustrated in FIG. 3, the plurality of receptacles 76 defined by the first surface 50 of the base 40 comprise a first pattern of receptacles 72. In addition, the plurality of apertures defined by the lid 90 (FIG. 4) comprise a second pattern 96. Preferably, the first pattern of receptacles 72 defined by the first surface of the base is substantially similar to the second pattern of apertures 96 defined by the lid 90. In this manner, as illustrated in FIG. 2, if a candle or flower is placed within aperture 94a defined by lid 90, a base or a bottom portion of this candle will also be able to be seated in a receptacle 74a residing immediately below this aperture 94a. The remaining apertures 94 defined by the lid 90 will also align themselves with the remaining receptacles 74 defined by the first surface 50 of the base 40. For example, in the apparatus illustrated in FIGS. 1-4, the lid 90 defines twenty one (21) apertures 94 and similarly, the first surface. 50 of the base 40 defines twenty one (21) receptacles 74. As such, when the lid 90 is positioned over the wall 80 as illustrated in FIG. 1, all twenty one (21) apertures defined by the lid 90 will align with the twenty one (21) receptacles defined by the first surface 50 of the base 40.

FIG. 4 illustrates a perspective view of a lid 90 that may be used with an apparatus 20 for use with at least one ignitable light source and/or at least one flower, such as the base 40 illustrated in FIG. 3. Referring now to FIGS. 1 and 4, the plurality of apertures defined by the lid 90 comprise a second pattern 92. In a preferred arrangement, the second pattern 92 of apertures defined by the lid 90 comprises a first circle of apertures 94 and a second circle of apertures 96. However, as those of ordinary skill in the art will recognize, alternative aperture configurations may also be used.

In this illustrated apparatus arrangement, the plurality of apertures 70 comprise a plurality of circular shaped apertures. As illustrated, each of the plurality of apertures 70 comprise a substantially similar size aperture. For example, in one preferred arrangement, the plurality of apertures comprise a diameter from about 0.25 to about 1.5 inches. In one preferred arrangement, the plurality of apertures comprise one or more different diameters.

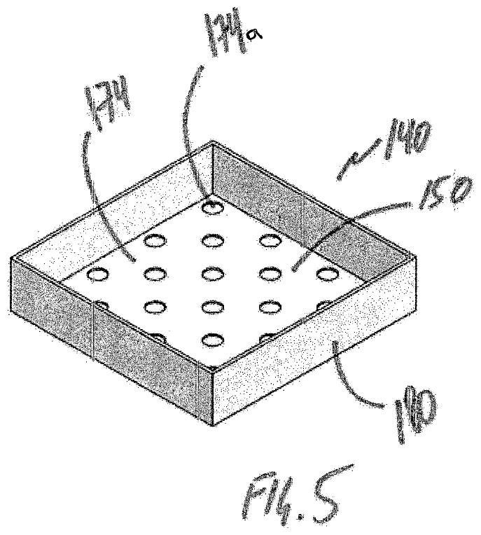

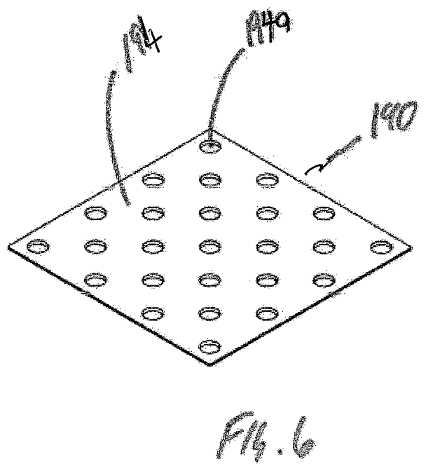

FIG. 5 illustrates a perspective view of an alternative base 140 that may be used with an apparatus for use with at least one ignitable light source and/or at least one flower. FIG. 6 illustrates a perspective view of a lid 190 that may be used with an apparatus for use with at least one ignitable light source and/or at least one flower, such as the base 140 illustrated in FIG. 5. Referring to FIGS. 5 and 6, the base 140 (substantially similar to the base 40 illustrated and described with reference to FIGS. 1-4) includes a top surface 150 that defines a plurality of receptacles 174. And the lid 190 (substantially similar to the lid 90 illustrated and described with reference to FIGS. 1-4) defines a plurality of apertures 194.

As illustrated, the first pattern of receptacles 174 defined by the first surface of the base 140 is substantially similar to a second pattern of apertures 194 defined by the lid 190. In this manner, if a candle or a flower is placed within aperture 194a defined by lid 190, a base or a bottom portion of this candle or flower will also be able to be seated in a receptacle 174a residing immediately below this aperture 194a. The remaining apertures 194 defined by the lid 190 will also align themselves with the remaining receptacles 174 defined by the first surface 150 of the base 140.

For example, in the apparatus illustrated in FIGS. 5-6, the lid 190 defines twenty five (25) apertures 194 and similarly, the first surface 150 of the base 140 defines twenty five (25) receptacles 174. As such, when the lid 190 is positioned over the wall 180, all twenty-five (25) apertures 194 defined by the lid 190 will align with the twenty-five (25) receptacles 174 defined by the first surface 150 of the base 140.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. An apparatus, comprising:
a base defining a first surface and a second surface, the first surface defining a plurality of receptacles for receiving one or more ignitable light sources and/or at least one flower;
a wall extending from the first surface of the base, and
a lid positioned along a rim defined by the wall, the lid defining a plurality of apertures for receive one or more ignitable light sources and/or the at least one flower.

2. The apparatus of claim 1 wherein
the plurality of receptacles defined by the first surface of the base comprises a first pattern of receptacles.

3. The apparatus of claim 2 wherein
the first pattern of receptacles comprises a first circle of receptacles and a second circle of receptacles.

4. The apparatus of claim 1 wherein
the plurality of apertures defined by the lid comprise a second pattern.

5. The apparatus of claim 4 wherein
the second pattern comprises a first circle of apertures and a second circle of apertures.

6. The apparatus of claim 1 wherein
the plurality of receptacles defined by the first surface of the base comprise a first pattern of receptacles,
the plurality of apertures defined by the lid comprise a second pattern,
wherein the first pattern of receptacles defined by the first surface of the base is substantially similar to the second pattern of apertures defined by the lid.

7. The apparatus of claim 1 wherein
the plurality of receptacles comprise a plurality of circular receptacles.

8. The apparatus of claim 1 wherein
the plurality of apertures comprise a plurality of circular apertures.

9. The apparatus of claim 1 wherein
each of the plurality of receptacles comprise a substantially similar size receptacle.

10. The apparatus of claim 1 wherein
each of the plurality of apertures comprise a substantially similar size aperture.

11. (canceled)

12. The apparatus of claim 6 wherein
the first size is substantially similar to the second size.

13. The apparatus of claim 1 wherein
the wall comprises a single wall structure.

14. The apparatus of claim 1 wherein
the lid is removably positioned along the rim of the wall.

15. The apparatus of claim 1 wherein
the lid is pivotably positioned along the rim of the wall.

16. (canceled)

17. (canceled)

18. The apparatus of claim 1 wherein
the lid comprises a first material,
the base comprises a second material: and
the first material is substantially similar to the second material.

19. The apparatus of claim 1 wherein
the lid comprises a first material,
the base comprises a second material; and
the first material or the second material comprises an acrylic.

20. The apparatus of claim 1 wherein
the plurality of receptacles comprise a depth of about 0.1 to about 0.250 inches.

21. The apparatus of claim 1 wherein
the plurality of apertures comprise a diameter of about 0.25 to about 1.5 inches.

22. The apparatus of claim 1 further comprising:
an alignment feature, the alignment feature assisting with an alignment of the lid when the lid is positioned on the rim of the wall.

23. The apparatus of claim 22 wherein
the plurality of receptacles defined by the base align with the plurality of apertures defined by the lid.

24. (canceled)

25. (canceled)
